(19) United States
(12) Patent Application Publication
(10) Pub. No.: US 2021/0081425 A1
(43) Pub. Date: Mar. 18, 2021

(54) SYSTEM SELECTION FOR QUERY HANDLING

(71) Applicant: Oracle International Corporation, Redwood Shores, CA (US)

(72) Inventors: Allison Marie Wayne, Wakefield, MA (US); Joshua Ulm, Greenbrae, CA (US); Sherry Mead, San Francisco, CA (US); Hillel Noah Cooperman, Seattle, WA (US); Lancy Jude Silveira, Foster City, CA (US); Kathleen Maguire Candland, San Francisco, CA (US); Richard Herbert Miller, Hillsborough, CA (US); Carmen Ximena D'Arlach, Austin, TX (US)

(73) Assignee: Oracle International Corporation, Redwood Shores, CA (US)

(21) Appl. No.: 16/924,034

(22) Filed: Jul. 8, 2020

Related U.S. Application Data
(60) Provisional application No. 62/900,216, filed on Sep. 13, 2019.

(51) Int. Cl. G06F 16/2457; G06F 16/25; G06N 20/00

(52) U.S. Cl. CPC G06F 16/24575; G06N 20/00; G06F 16/252

(57) ABSTRACT

Techniques for system selection for query handling are disclosed. A query response selection system may receive a query from a user and determine attributes corresponding to the query and/or candidate sets of search results that may be displayed in response to the query. The system may select a response interface from one of a plurality of response interfaces for responding to the query. The plurality of response interfaces may include a conversational user interface and a non-conversational user interface. The system may display the response interface with a response to the query.

### INCORPORATION BY REFERENCE; DISCLAIMER

This application is hereby incorporated by reference: application No. 62/900,216 filed on Sep. 13, 2019. The Applicant hereby rescinds any disclaimer of claim scope in the parent application or the prosecution history thereof and advises the USPTO that the claims in this application may be broader than any claim in the parent application.

### TECHNICAL FIELD

The present disclosure relates to selection of a system for handling a query. In particular, the present disclosure relates to a system selecting one of a heterogeneous plurality of systems for handling the query.

### BACKGROUND

Conventional query response systems respond to each query with the same response strategy. For example, a system can: provide one or more links to information, provide access to a help page, perform a task in response to the query, or provide access to a conversational interface. That is, while the content of each query response can change, the system for handling the response is statically configured.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for selecting a system for query handling in accordance with one or more embodiments;

FIGS. 3A-3E show examples of selecting a system for query handling in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. SYSTEM SELECTION FOR QUERY HANDLING

4. EXAMPLE EMBODIMENT

5. MISCELLANEOUS; EXTENSIONS

6. HARDWARE OVERVIEW

### 1. General Overview

One or more embodiments select a type of a query response interface for presenting a response to a query. The type of query response interface may be selected based on one or more of: attributes of a query, and search results to be presented in response to the query. The type of query response interface may be selected based a confidence level associated with each set of search results determined for the query. Each set of search results may be obtained by a different corresponding system, and be associated with a different corresponding level of confidence. The particular set of search results with the highest level of confidence may be selected for presentation to the user. An interface that is best suited for presenting the particular set of search results is selected for presenting the particular set of search results.

In an embodiment, based on query attributes, the system may select either a conversational interface or a non-conversational interface for responding to the query. A conversational interface may include, for example, a chat interface in which system-selected information is presented within natural language sentences. A conversational interface may also present a single search result and attempt to determine if that single search result is what the user is searching for. A non-conversational interface may include, for example, an interface that presents lists of search results. Different types of interfaces may also provide different options. As an example, a conversational interface may ask a user if the user would like to execute a particular operation that is (a) related to a query response and (b) is typically executed by users that have executed the same query. Alternatively, a non-conversational interface may simply display a set of links to a set of search results, without prompting the user for any particular operation.

One or more embodiments further select a particular subtype of a conversational interface or a particular subtype of a non-conversational interface for responding to a query. Different subtypes of interfaces may include different functionality/features, present responses in different manners, and present varying levels of information details. As an example, a first type of conversational interface may only present text in response to a query. In contrast, a second type of conversational interface may concurrently present both text and media in response to a query.

One or more embodiments described in this Specification and/or recited in the claims may not be included in this General Overview section.

### 2. Architectural Overview

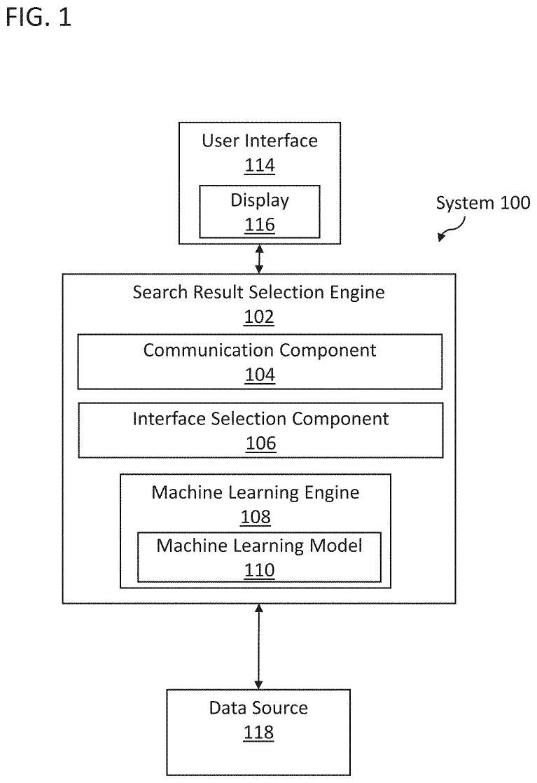

FIG. 1 illustrates a system 100 in accordance with one or more embodiments. As illustrated in FIG. 1, system 100 includes a search result selection engine 102, a user interface 114, an external data source 118, and various components thereof. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, the user interface 114 refers to hardware and/or software configured to facilitate communications between a user and the search result selection engine 102. The user interface 114 may be used by a user who accesses an interface (e.g., a dashboard interface) for work and/or personal activities. The user interface 114 may be associated with one or more devices for presenting visual media, such as a display 116, including a monitor, a television, a projector, and/or the like. User interface 114 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In particular, the user interface 114 may include multiple heterogeneous query interfaces. For example, the user interface may include one or more of a conversational interface, an interactive interface, a directive interface, and help database interface.

In some embodiments, the user interface 114 includes a conversational interface. The conversational interface may allow for communication between the system and the user that emulates communication between two humans. In particular, rather than forcing a user to translate a desired action into commands that a computer typically understands, the conversational interface allows a user to communicate using natural language. To do this, the conversational interface may use natural language processing and/or natural language understanding to allow the system to understand, analyze, and create meaning from human language. Natural language processing may consider the structure of human language (e.g., words make phrases; phrases make sentences which convey the idea or intent the user is trying to invoke) when analyzing the natural language input. Natural language understanding may allow for sentiment analysis and/or conversational searches which allow a line of questioning to continue, with the context carried throughout the conversation. Natural language understanding may allow the conversational interface to handle unstructured inputs that the human brain is able to understand, such as spelling mistakes and/or follow-up questions. For example, through leveraging natural language understanding, a user could first ask for the population of the United States. If the user then asks, “Who is the president?”, the search may carry forward the context of the United States and provide the appropriate response.

In some embodiments, the user interface 114 includes an interactive interface. The interactive interface may direct a user to one or more applications or programs, stored locally on a user device or maintained by the system, either on the system or on another computer accessible by the system. The interface may provide a query to an interaction index. The interaction index may be used to select one or more applications for access by a user based on one or more of the user credentials and/or the query terms.

In some embodiments, the user interface 114 includes a directive interface. The directive interface may function in a manner similar to a web search engine by interfacing with a directory index to provide links (e.g., uniform resource locators) to one or more resources on a network (e.g., a local area network and/or the Internet).

In some embodiments, the user interface 114 may include a help database interface. The help database interface may allow the user to retrieve results from a help database maintained by the system. The help database may retrieve one or more articles based on the query entered by the user.

In an embodiment, different components of the user interface 114 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the user interface 114 is specified in one or more other languages, such as Java, C, or C++.

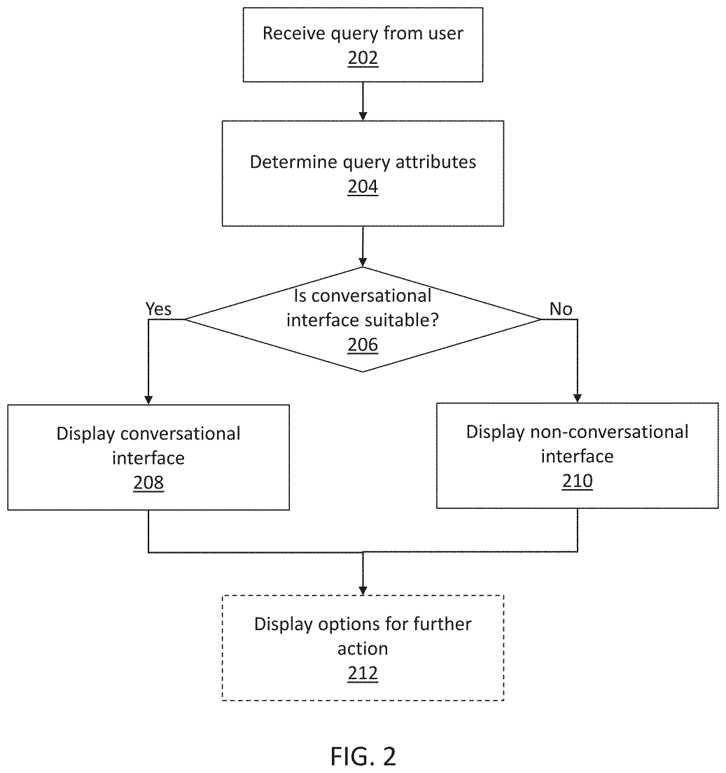

In one or more embodiments, a search result selection engine 102 refers to hardware and/or software configured to perform operations described herein for selecting query results to display to a user. Examples of operations for selecting query results to display to a user are described below with reference to FIG. 2.

In an embodiment, the search result selection engine 102 includes a communication component 104. A communication component 104 may refer to hardware and/or software configured to perform operations described herein (including such operations as may be incorporated by reference) for recognizing input from a user.

In an embodiment, the search result selection engine 102 includes an interface selection component 106. An interface selection component 106 may refer to hardware and/or software configured to select an interface from among the plural heterogeneous interfaces maintained by the system.

In an embodiment, one or more components of the search result selection engine 102 use a machine learning engine 108. Machine learning includes various techniques in the field of artificial intelligence that deal with computer-implemented, user-independent processes for solving problems that have variable inputs.

In some embodiments, the machine learning engine 108 trains a machine learning model 110 to perform one or more operations. Training a machine learning model 110 uses training data to generate a function that, given one or more inputs to the machine learning model 110, computes a corresponding output. The output may correspond to a prediction based on prior machine learning. In an embodiment, the output includes a label, classification, and/or categorization assigned to the provided input(s). The machine learning model 110 corresponds to a learned model for performing the desired operation(s) (e.g., labeling, classifying, and/or categorizing inputs). A search engine selection engine 102 may use multiple machine learning engines 108 and/or multiple machine learning models 110 for different purposes.

In an embodiment, the machine learning engine 108 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine 108 receives positive and/or negative reinforcement in the process of attempting to solve a particular problem (e.g., to optimize performance in a particular scenario, according to one or more predefined performance criteria). In an embodiment, the machine learning engine 108 initially uses supervised learning to train the machine learning model 110 and then uses unsupervised learning to update the machine learning model 110 on an ongoing basis.

In an embodiment, a machine learning engine 108 may use many different techniques to label, classify, and/or categorize inputs. A machine learning engine 108 may transform inputs into feature vectors that describe one or more properties (“features”) of the inputs. The machine learning engine 108 may label, classify, and/or categorize the inputs based on the feature vectors. Alternatively or additionally, a machine learning engine 108 may use clustering (also referred to as cluster analysis) to identify commonalities in the inputs. The machine learning engine 108 may group (i.e., cluster) the inputs based on those commonalities. The machine learning engine 108 may use hierarchical clustering, k-means clustering, and/or another clustering method or combination thereof. In an embodiment, a machine learning engine 108 includes an artificial neural network. An artificial neural network includes multiple nodes (also referred to as artificial neurons) and edges between nodes. Edges may be associated with corresponding weights that represent the strengths of connections between nodes, which the machine learning engine 108 adjusts as machine learning proceeds. Alternatively or additionally, a machine learning engine 108 may include a support vector machine. A support vector machine represents inputs as vectors. The machine learning engine 108 may label, classify, and/or categorizes inputs based on the vectors. Alternatively or additionally, the machine learning engine 108 may use a naïve Bayes classifier to label, classify, and/or categorize inputs. Alternatively or additionally, given a particular input, a machine learning model may apply a decision tree to predict an output for the given input. Alternatively or additionally, a machine learning engine 108 may apply fuzzy logic in situations where labeling, classifying, and/or categorizing an input among a fixed set of mutually exclusive options is impossible or impractical. The aforementioned machine learning model 110 and techniques are discussed for exemplary purposes only and should not be construed as limiting one or more embodiments.

In an embodiment, as a machine learning engine 108 applies different inputs to a machine learning model 110, the corresponding outputs are not always accurate. As an example, the machine learning engine 108 may use supervised learning to train a machine learning model 110. After training the machine learning model 110, if a subsequent input is identical to an input that was included in labeled training data and the output is identical to the supervisory signal in the training data, then output is certain to be accurate. If an input is different from inputs that were included in labeled training data, then the machine learning engine 108 may generate a corresponding output that is inaccurate or of uncertain accuracy. In addition to producing a particular output for a given input, the machine learning engine 108 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In particular, the machine learning model 110 may receive, as inputs, query data and or user characteristics. The machine learning model 110 may use at least historical query data to output, for example a selection of interface to the interface selection component 106. In some embodiments, the machine learning model 110 may output a confidence indicator in addition to the interface selection.

In an embodiment, the search result selection engine 102 is configured to receive data from one or more external data sources 118. An external data source 118 refers to hardware and/or software operating independent of the search result selection engine 102. For example, the hardware and/or software of the external data source 118 may be under control of a different entity (e.g., a different company or other kind of organization) than an entity that controls the query suggestion engine. An external data source 118 may supply data associated with a pool of search results from which the search result selection engine can select the best result to respond to the received query. An example of an external data source 118 supplying data to a search result selection engine 102 may include a third party search engine. Many different kinds of external data sources 118 may supply many different kinds of data.

In an embodiment, search result selection engine 102 is configured to retrieve data from an external data source 118 by ‘pulling’ the data via an application programming interface (API) of the external data source 118, using user credentials that a user has provided for that particular external data source 118. Alternatively or additionally, an external data source 118 may be configured to ‘push’ data to the search result selection engine 102 via an API of the query suggestion service, using an access key, password, and/or other kind of credential that a user has supplied to the external data source 118. A search result selection engine 102 may be configured to receive data from an external data source 118 in many different ways.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

### 3. System Selection for Query Handling

FIG. 2 illustrates an example set of operations for selecting a system for query handling in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, a system (e.g., one or more components of system 100 illustrated in FIG. 1) can display an interface including at least an interface element through which the system may receive a query. The interface element may include, for example, a text entry field. The system may receive a query from a user (Operation 202) via the interface element. In some embodiments, the system may receive a text query. Alternatively, the system may receive a query via other means, such as via an audio input.

In an embodiment, the system may determine one or more attributes of the received query and/or attributes related to one or more potential responses to the query (Operation 204). For example, in some embodiments, the system may perform a parsing algorithm on the query to determine one or more components of the query. In particular, the system may perform a keyword analysis on a query to determine a particular action requested by the query. The system may further perform semantic analysis of the query to determine additional input data. As a particular example, given a query structured as “John Doe's phone number,” the system may perform an analysis (e.g., a keyword analysis) to determine that the phrase “phone number” is present in the received query and that the query represents a query for contact information. The system may perform a further analysis (e.g., a meaning analysis) to determine that an object of the contact information request is also present in the query (e.g., the name “John Doe”).

In some embodiments, the system determines device information corresponding to a device used to enter the query. For example, the system may determine a device type (e.g., laptop or desktop computer, smartphone, tablet, etc.). The one or more attributes of the received query may include the device information.

The system determines whether a conversational interface is suitable (Operation 206) based on the attributes of either the query or the potential responses to the query. For example, the system may determine, based on the attributes of the query and/or the potential responses to the query, that further interaction is expected form the user and thus a conversational query response is more suitable.

In embodiments, the one or more potential responses can be determined from a heterogeneous plurality of query response sources (e.g., a conversational query response engine and one or more traditional, non-conversational response engines).

In some embodiments, the attributes may include a confidence level that a query response is fully responsive to the query and/or useful to the user. For example, the system can determine that a conversational query response may identify information with 90% confidence level, while a non-conversational query response may identify information with 70% confidence level.

In some embodiments, the attributes may include an indication that the system requires additional user input to provide a useful query response. For example, if a user enters the query “where do I file state taxes” and the system is lacking residence information for the user, the system may determine that a query interface is suitable to request the residence information.

In some embodiments, the attributes may include prior success metrics. For example, the percentage of times that a user interacted with one of the provided search results for the same or a similar query, the percentage of times that a user entered a similar query without interacting with any search results, user survey information regarding satisfaction with results, and the like.

In some embodiments, the attributes may include historical data for similar queries. For example, where users follow up a similar query with additional queries, the system may be more likely to determine that a conversational interface is suitable to retain context for the additional queries.

In some embodiments, the attributes may include the type of data to be presented as a result of the query. For example, where a query has a single, textual response, it may be better suited for a conversational interface; where a query requires presentation of more complex data, the query may be better suited for a non-conversational interface.

In some embodiments, the attributes may include one or more keyword elements extracted from a query via a parsing operation. In some embodiments the system may further perform a lexical analysis of the extracted keyword elements to generate additional keyword elements (e.g., identifying synonyms). The lexical analysis may be performed, for example, using a machine learning engine. The system may determine whether a query is suited to a conversational interface based on the extracted keyword elements. As an example, the system may determine particular keyword elements are best suited for a conversational interface. In some embodiments, identification of any keywords functions can result in use of the conversational interface.

Accordingly, different systems may process the same query and determine that different interfaces are appropriate for response. As an example, two systems may receive a user query “How much vacation time do I have?”. A first system can determine that a non-conversational interface is capable of providing a query response with 100% certainty, and thus respond to the query using a non-conversational interface. A second system receiving the same query may determine that users who enter such a query typically present additional follow-up queries (e.g., to schedule vacation and/or to determine how vacation time is accrued), and thus respond to the initial query with a conversational interface.

In at least some embodiments, the system may determine one or more candidate sets of search results. For example, the system may determine a set of search results associated with a subset (e.g., each) of the heterogeneous plurality of query response sources. The system can further determine a confidence indicator associated with each of the candidate sets of search results. The system can select an interface based on one or more of the candidate sets of search results associated with the query response source, and/or the confidence indicator. One or more embodiments display an interface based on the determination in Operation 206.

In response to determining that the received query is best suited for a conversational interface, the system displays a conversational interface (Operation 208). For example, the system may call a method associated with the conversational interface, the method causing the system to display the conversational interface. In embodiments, displaying the conversational interface may include displaying an interface that includes functionality to respond to a natural-language user query using, for example, natural language processing and/or natural language understanding. The interface allows a conversational query response engine to provide a response to a submitted query to the user in a conversational manner, and to receive and respond to additional queries in a conversational manner while maintaining context. In some embodiments, displaying the conversational interface may further include displaying the received query as a first input from the user, and displaying a system-generated response using the conversational interface. In embodiments, the conversational interface receives, as input, text of the query. The conversational interface can parse the query to determine one or more components of the query. The determined components can be used as input to the conversational interface to assist in completing a task. For example, if the user enters a query for “$20 taxi expense today,” the system can parse the query for information including an action type (e.g., expense), a dollar amount (e.g., $20), a date (e.g., today), and a description (e.g., taxi).

Alternatively, in response to determining that the received query is not best suited for a conversational interface, the system can display a non-conversational interface for responding to the query (Operation 210). For example, the system may call a method associated with the selected non-conversational interface, the method causing the system to display the non-conversational interface. In some embodiments, displaying the non-conversational interface can first comprise selecting one of a plurality of heterogeneous non-conversational interfaces. As an example, the system may choose between a task-based query response interface for performing a task in response to the received query, a navigation-based query response interface for providing shortcuts that allow a user to navigate to some information in response to the received query, and a help interface. In embodiments, the selected interface may be displayed. In some embodiments, displaying the non-conversational interface may further include displaying the received query as a first input from the user, and displaying a system-generated response using the selected non-conversational interface.

In an embodiment, the system may display options for further action (Operation 210). The options for further action may include, for example, system features related to the query and/or query response, additional queries. In some embodiments, the options for further action may include at least one option determined by the system to be the next best action for the user. For example, the next best action may be an action that is most often performed following the received query. As a particular example, if the received query is “do I have any PTO left,” the options for further action may include “submit time off.” In some embodiments, options for further action are display in the conversational interface, but not displayed in the non-conversational interface.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

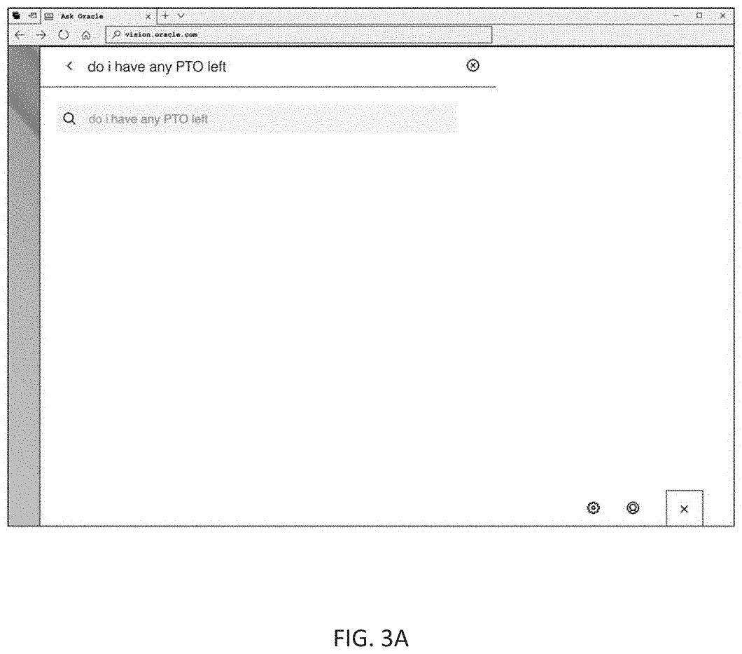

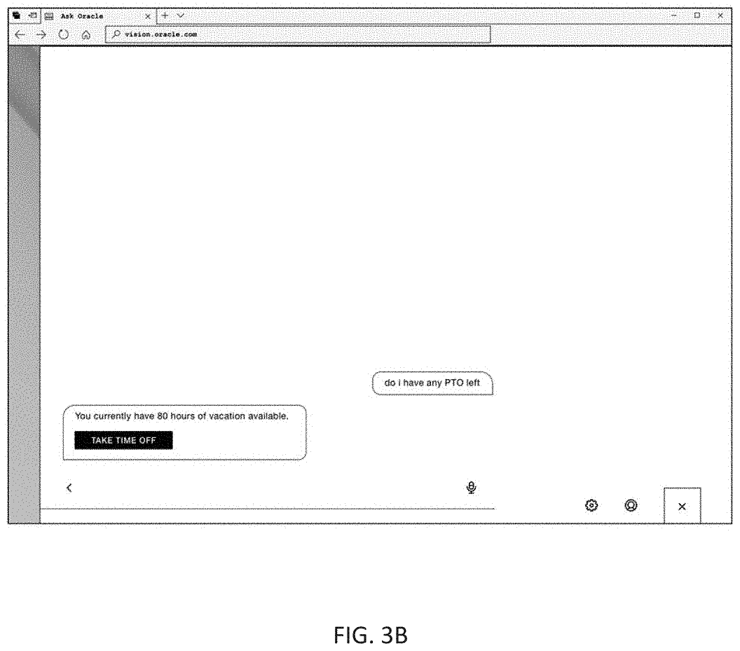

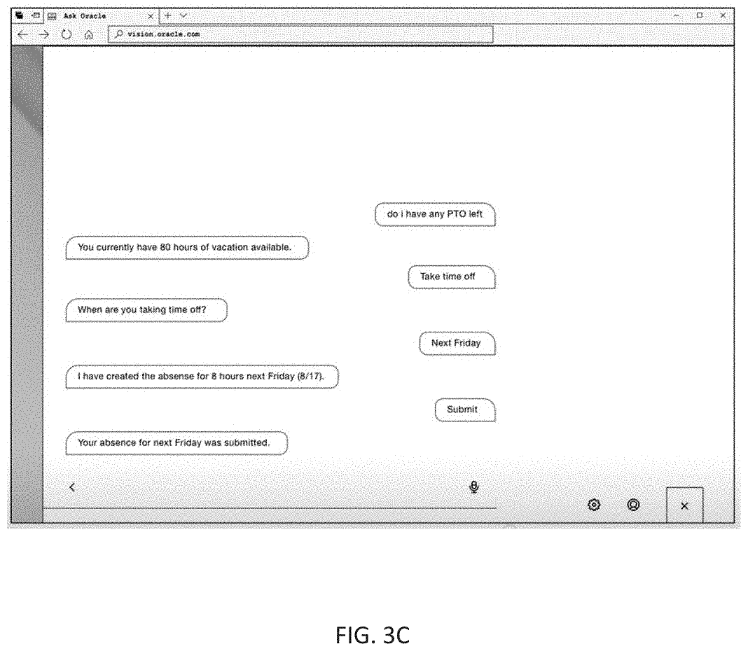

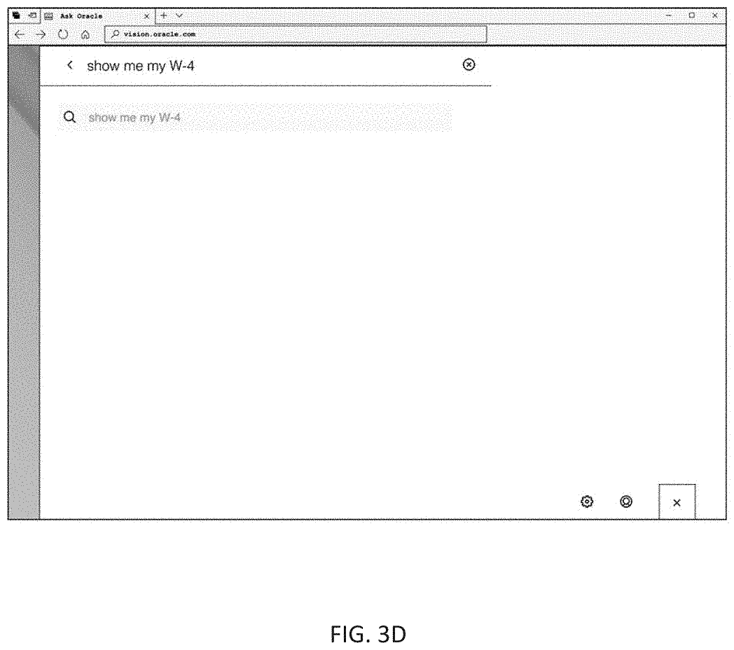

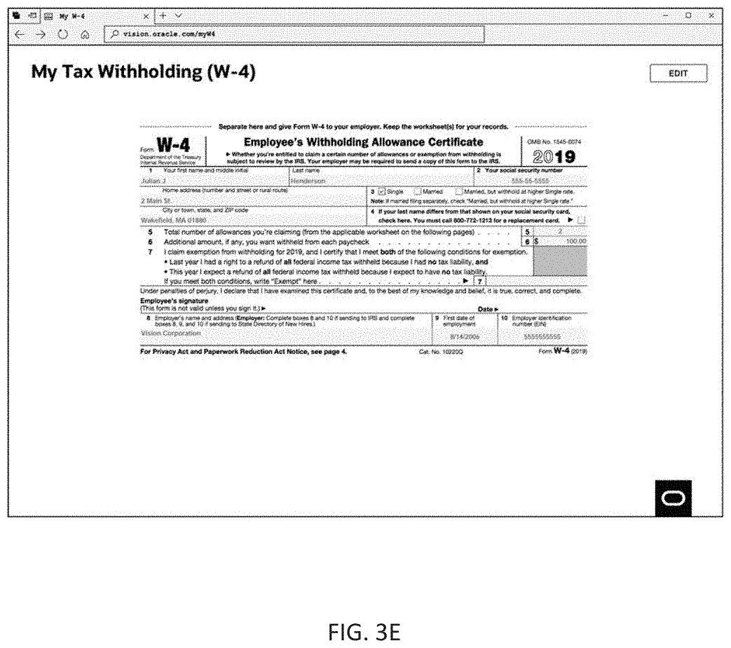

FIGS. 3A-3E illustrate particular examples in accordance with the one or more embodiments. As illustrated in FIG. 3A, the system receives a first query. The received first query is “do I have any PTO left.” As illustrated in FIG. 3B. the system determines that the received query is best answered via a conversational interface. Accordingly, the system displays the conversational interface, including showing the received query as a first input from the user. As shown in FIG. 3B, the system further displays a system-generated response to the query (e.g., “You currently have 80 hours of vacation available”) using the conversational interface. Further, the system provides an option for further action (e.g., “TAKE TIME OFF”) to the user. As illustrated in FIG. 3C, when the user interacts with the displayed option for further action, such as by clicking on the action, the conversational interface progresses, showing “Take time off” as an input from the user. The system requests further details regarding the time off the user wishes to schedule through the conversational interface. The system also submits the time off request in response to a user instruction to do so.

As a further example, FIG. 3D shows that the system receives a second query. The received second query is “show me my W-4.” As illustrated in FIG. 3E. the system determines that the received query is best answered via a non-conversational interface. Accordingly, the system selects an interface for responding to the query and displays the non-conversational interface, including a system-generated response to the query (e.g., the text “My Tax Withholding (W-4)” and an image of the W-4 document) using the selected non-conversational interface.

### 5. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

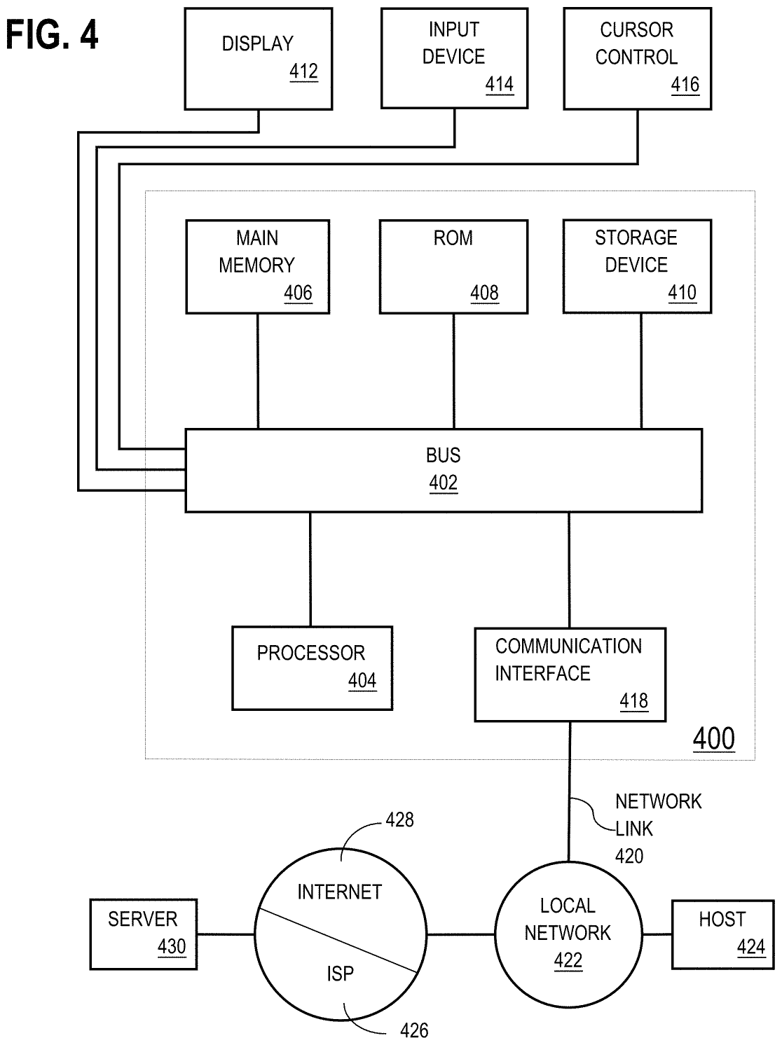

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory media comprising instructions which, when executed by one or more hardware processors, causes performance of operations comprising:
receiving a query from a user;
determining attributes corresponding to at least one of: (a) the query, or (b) candidate sets of search results that may be displayed in response to the query;
based on the attributes: selecting a response interface from one of a plurality of response interfaces for responding to the query, wherein the plurality of response interface comprises a conversational user interface and a non-conversational user interface; and
displaying the response interface with a response to the query.

2. The one or more non-transitory media of claim 1, wherein the non-conversational user interface comprises one or more of a task execution user interface, and information presentation user interface, or a help user interface.

3. The one or more non-transitory media of claim 1, wherein selecting the response interface comprises:
determining a confidence level associated with each a plurality of candidate responses to the query;
selecting a candidate response of the plurality of candidate responses as the response to the query for displaying to the user based on the confidence level associated with the candidate response; and
selecting the response interface based on the selected response to the query.

4. The one or more non-transitory media of claim 1, wherein selecting the response interface comprises:
determining a prior success metric associated with each of a plurality of candidate responses to the query;
selecting a candidate response of the plurality of candidate responses as the response to the query for displaying to the user based on the prior success metric associated with the candidate response; and
selecting the response interface based on the selected response to the query.

5. The one or more non-transitory media of claim 1, wherein selecting the response interface comprises selecting the one of the plurality of heterogeneous data sources based on the one or more attributes of the query.

6. The one or more non-transitory media of claim 5, wherein the one or more attributes comprise at least one of an indication that a topic of the query is suitable for a conversational interface, an indication of whether users typically take an action subsequent to executing the query, or historical data indicating a type of action taken by users subsequent to execution of the query.

7. The one or more non-transitory media of claim 1, further comprising instructions which, when executed by one or more hardware processors, cause displaying one or more options for further action to a user via the interface associated with the selected data source.

8. A system comprising:
at least one device including a hardware processor;
the system being configured to perform operations comprising:
receiving a query from a user;
determining attributes corresponding to at least one of: (a) the query, or (b) candidate sets of search results that may be displayed in response to the query;
based on the attributes: selecting a response interface from one of a plurality of response interfaces for responding to the query, wherein the plurality of response interface comprises a conversational user interface and a non-conversational user interface; and
displaying the response interface with a response to the query.

9. The system of claim 8, wherein the non-conversational user interface comprises one or more of a task execution user interface, and information presentation user interface, or a help user interface.

10. The system of claim 8, wherein selecting the response interface comprises:
determining a confidence level associated with each a plurality of candidate responses to the query;
selecting a candidate response of the plurality of candidate responses as the response to the query for displaying to the user based on the confidence level associated with the candidate response; and
selecting the response interface based on the selected response to the query.

11. The system of claim 8, wherein selecting the response interface comprises:
determining a prior success metric associated with each of a plurality of candidate responses to the query;
selecting a candidate response of the plurality of candidate responses as the response to the query for displaying to the user based on the prior success metric associated with the candidate response; and
selecting the response interface based on the selected response to the query.

12. The one or more non-transitory media of claim 1, wherein selecting the response interface comprises selecting the one of the plurality of heterogeneous data sources based on the one or more attributes of the query.

13. The system of claim 12, wherein the one or more attributes comprise at least one of an indication that a topic of the query is suitable for a conversational interface, an indication of whether users typically take an action subsequent to executing the query, or historical data indicating a type of action taken by users subsequent to execution of the query.

14. The system of claim 8, further comprising instructions which, when executed by one or more hardware processors, cause displaying one or more options for further action to a user via the interface associated with the selected data source.

15. A method comprising:
receiving a query from a user;
determining attributes corresponding to at least one of: (a) the query, or (b) candidate sets of search results that may be displayed in response to the query;
based on the attributes: selecting a response interface from one of a plurality of response interfaces for responding to the query, wherein the plurality of response interface comprises a conversational user interface and a non-conversational user interface; and
displaying the response interface with a response to the query,
wherein the method is executed by at least one device comprising a hardware processor.

16. The method of claim 15, wherein the non-conversational user interface comprises one or more of a task execution user interface, and information presentation user interface, or a help user interface.

17. The method of claim 15, wherein selecting the response interface comprises:
determining a confidence level associated with each a plurality of candidate responses to the query;
selecting a candidate response of the plurality of candidate responses as the response to the query for displaying to the user based on the confidence level associated with the candidate response; and
selecting the response interface based on the selected response to the query.

18. The method of claim 15, wherein selecting the response interface comprises:
determining a prior success metric associated with each of a plurality of candidate responses to the query;
selecting a candidate response of the plurality of candidate responses as the response to the query for displaying to the user based on the prior success metric associated with the candidate response; and
selecting the response interface based on the selected response to the query.

19. The method of claim 15, wherein selecting the response interface comprises selecting the one of the plurality of heterogeneous data sources based on the one or more attributes of the query.

20. The method of claim 15, further comprising instructions which, when executed by one or more hardware processors, cause displaying one or more options for further action to a user via the interface associated with the selected data source.
